(19) United States
(12) Patent Application Publication
(10) Pub. No.: US 2018/0208106 A1
(43) Pub. Date: Jul. 26, 2018

(54) ILLUMINATED TRAILER TOW HITCH RECEIVER ASSEMBLY

(71) Applicant: FORD GLOBAL TECHNOLOGIES, LLC, Dearborn, MI (US)

(72) Inventors: John Patrick Doyle, II, Commerce Township, MI (US); Donald P. Iacovoni, Plymouth, MI (US); Paul L. Heirtzler, JR., Northville, MI (US)

(21) Appl. No.: 15/412,747

(22) Filed: Jan. 23, 2017

(51) Int. Cl. B60Q 1/26; B60D 1/06; B60Q 1/00

(52) U.S. Cl. CPC B60Q 1/2661; B60Q 1/0076; B60Q 1/0088; B60D 1/06

(57) ABSTRACT

An illuminated hitch receiver assembly for a vehicle includes a light source associated with one of a hitch receiver or a drawbar. A light source actuator is associated with a vehicle-mounted wiring connector or a light source connector. The light source actuator may be one of a capacitive switch, a touch switch, or a push switch. The light source may be integral to a portion of the receiver or may be releasably connected to the drawbar.

### TECHNICAL FIELD

This disclosure relates generally to vehicle hitch receiver assemblies. In particular, the disclosure relates to an illuminated vehicle hitch receiver assembly.

### BACKGROUND

FIG. 1 illustrates a vehicle 100 carrying the well-known basic configuration of a vehicle hitch receiver assembly 110. As shown, the vehicle hitch receiver assembly 110 typically comprises at least a hitch receiver 120 defining a receiver 130 for receiving a drawbar (not shown), the hitch receiver 120 being secured to a vehicle 100 frame (not shown) or bumper (not shown) by welding, by one or more brackets (not shown), or both. Connectors 140, 150 may be provided for placing trailer wiring harness connectors of varying design and configuration (not shown) in electrical communication with a vehicle 100 power source such as a battery (not shown). The hitch receiver 120 may further include associated safety chain loops 160 to which safety chains (not shown) can be attached. As is known, safety chains provide a secondary safety measure during a towing operation. The hitch receiver 120 side walls may include aligned apertures 165 for receiving a pin (not shown) to secure an inserted drawbar (not shown) in place.

Particularly when attempting to connect a trailer hitch to a vehicle hitch receiver assembly 110 in low-light conditions, the user is hampered in visualizing the various components thereof, and may have difficulty in securing a trailer hitch (not shown) to a drawbar (not shown) attached to the hitch receiver assembly 110. Moreover, as shown in FIG. 1 the typical vehicle hitch receiver assembly is at least partially obscured from a user's view by a vehicle fascia 170 and/or bumper (obscured by the fascia 170 in this view). This is especially so from the typical top plan perspective view (see FIG. 2) at which the user would be viewing the fascia 170 and hitch receiver assembly 110 (not visible in this view).

This could be solved by a user carrying a light source such as a flashlight, but this is inconvenient in that the user typically must use both hands to complete the task of securing the trailer hitch to the drawbar. An additional user holding the flashlight is another possible solution, but one that is often not available.

Accordingly, a need is identified in the art for improved vehicle hitch receiver assemblies, particularly comprising lighting systems allowing improved viewing of the vehicle hitch receiver assembly 110, the trailer hitch (not shown), etc. during the trailer hook-up process.

### SUMMARY

In accordance with the purposes and benefits described herein, in one aspect of the present disclosure an illuminated receiver hitch assembly is provided, comprising a light source associated with one of a hitch receiver or a drawbar and a light source actuator. The light source actuator may be one of a capacitive switch, a touch switch, a push switch, or any suitable actuator or activation method/device. In embodiments, the light source may be selected from the group consisting of one or more electroluminescent strips, one or more light-emitting diode (LED) strips, one or more printed LED strips, one or more LED bulbs, one or more luminescent optical fibers, one or more halogen bulbs, one or more fluorescent bulbs, one or more incandescent bulbs, any other type of suitable light source, and combinations. Alternatively, the light source may be powered via the various electrical connections described herein, and/or by a backup power source such as an associated battery or regenerative source/storage device including but not limited to solar or electro-mechanical generation such as are found in non-winding watches.

In one embodiment, the light source is integral to a portion of the hitch receiver. The light source may be carried by the main body of the hitch receiver, or the hitch receiver may comprise a light source-carrying flange. The light source actuator may be carried by the vehicle-mounted wiring connector whereby the simple act of connecting wiring such as a trailer wiring harness, or even of positioning a user hand adjacent the vehicle-mounted wiring connector, concurrently triggers the light source actuator.

In an alternative embodiment, the light source may be connected to the drawbar by a fastener selected from one or more straps, one or more zip ties, one or more clamps, adhesive bonding, bolts or screws, studs, a clip-on feature, any other suitable attachment method, or combinations. In this embodiment, the assembly may further include light source wiring and a light source connector adapted for placing the light source in electrical communication with a power source by way of the vehicle-mounted wiring connector. The light source connector may be a pass-through connector.

In another aspect, an illuminated hitch receiver comprising an integral light source is provided. The integral light source may be actuated by a light source actuator associated with a vehicle-mounted wiring connector. In embodiments, the light source actuator may be one of a capacitive switch, a touch switch, a push switch, or any suitable actuator or activation method/device. Particular light sources may be selected as described above. The light source may be carried by the main body of the hitch receiver, or the hitch receiver may comprise a light source-carrying flange.

In yet another aspect, a light source adapted for connecting to a drawbar for a vehicle receiver hitch assembly is provided. The light source may be adapted for connecting to the drawbar by a fastener selected from one or more straps, one or more zip ties, one or more clamps, adhesive bonding, bolts or screws, studs, a clip-on feature, any other suitable attachment method, or combinations. The light source may be provided with wiring and a light source connector adapted for placing the light source in electrical communication with a power source by way of a vehicle-mounted wiring connector. In embodiments, the light source connector is a pass-through connector.

In the following description, there are shown and described embodiments of the disclosed illuminated receiver hitch assembly. As it should be realized, the devices are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed illuminated receiver hitch assembly, and together with the description serve to explain certain principles thereof. In the drawings:

FIG. 1 shows a rear view of a prior art hitch receiver assembly disposed below a vehicle fascia;

FIG. 2 shows a top plan view of the vehicle fascia of FIG. 1;

FIG. 3 shows a rear perspective view of an embodiment of an illuminated hitch receiver assembly according to the present disclosure;

FIG. 4 shows a top plan view of an alternative embodiment of the illuminated hitch receiver assembly of FIG. 3;

FIG. 5 shows a rear perspective view of an embodiment of an illuminated hitch receiver assembly according to the present disclosure including light source actuators;

FIG. 6 shows yet another embodiment of an illuminated hitch receiver assembly according to the present disclosure; and

FIG. 7 shows a side cross-sectional view of a light source connector for the illuminated hitch receiver assembly of FIG. 6.

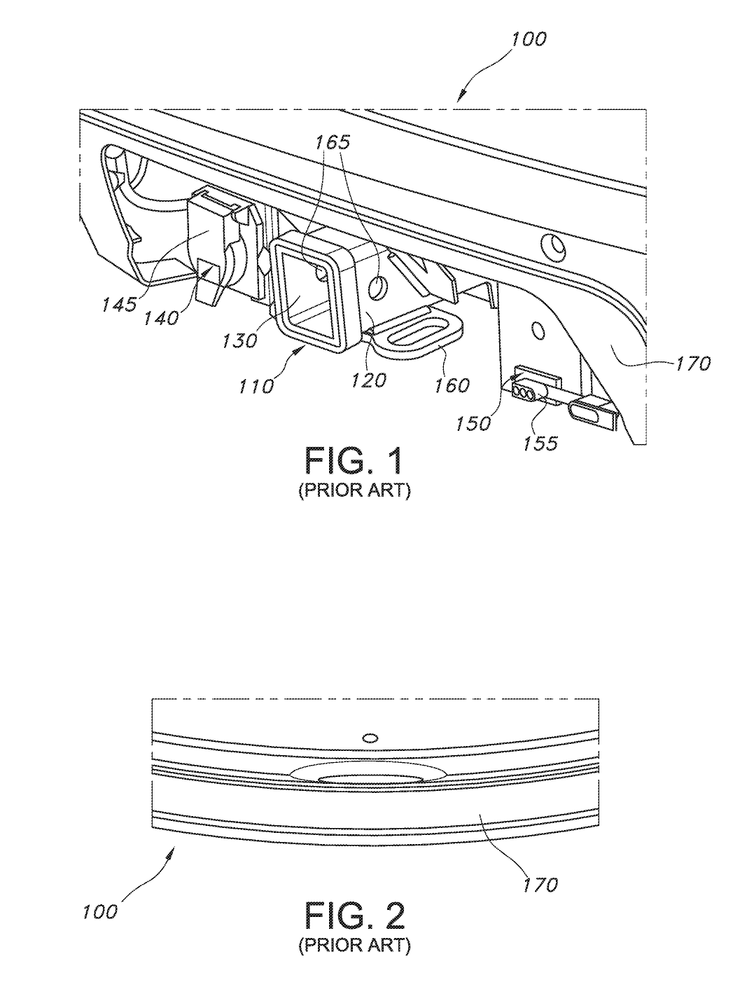

Reference will now be made in detail to embodiments of the disclosed illuminated receiver hitch assembly, examples of which are illustrated in the accompanying drawing figures. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

### DETAILED DESCRIPTION

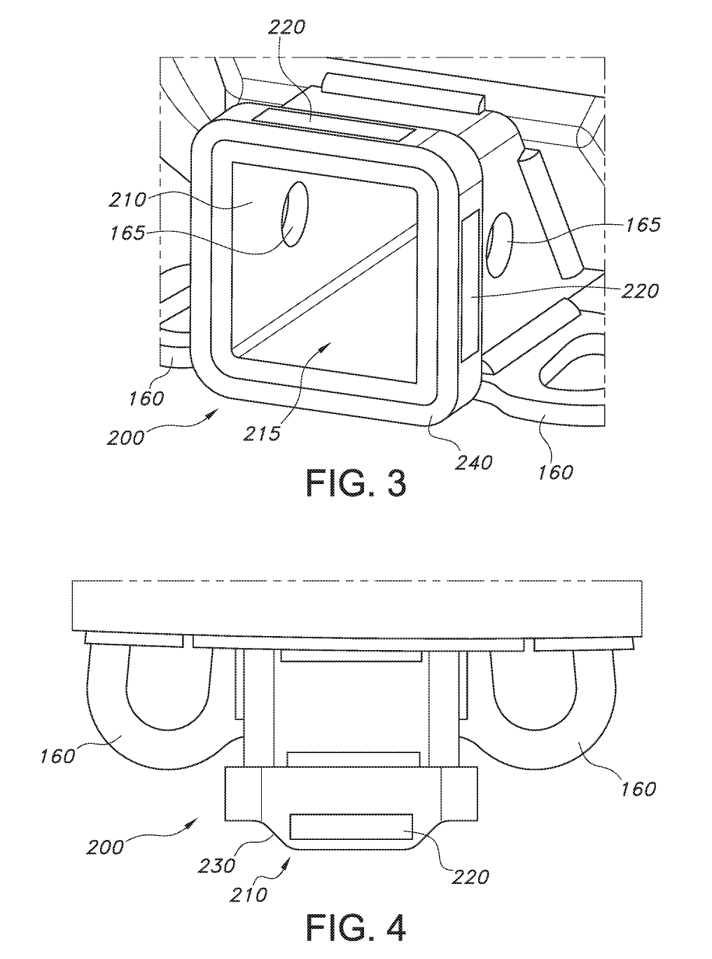

FIG. 3 illustrates an illuminated hitch receiver 200 according to the present disclosure. As shown therein, the illuminated hitch receiver 200 is defined by a tube which in turn defines a receiver portion 210 defining a mouth 215 into which a drawbar (not shown) may be inserted and secured. One or more light sources 220 are provided, in the depicted embodiment being integral to a portion of the illuminated hitch receiver 200 adjacent the receiver portion 210. In an alternative embodiment, one or more light source-carrying flanges 230 may be provided in various geometries or configurations relative to the receiver portion 210 to support one or more light sources 220. A representative though non-limiting example of such a geometry is depicted in FIG. 4.

Use of various types of light-emitting structures, substances, and devices as light sources 220 is contemplated. For example, it is contemplated to use one or more electroluminescent strips, one or more light-emitting diode (LED) strips, one or more printed LED strips, one or more LED bulbs, one or more luminescent optical fibers, one or more halogen bulbs, one or more fluorescent bulbs, one or more incandescent bulbs, or combinations thereof. The light sources 220 may be embedded into the material of the illuminated hitch receiver 200, or as shown in FIG. 3 may be embedded into a second material 240 surrounding the mouth 215 of the receiver portion 210. This second material 240 may be a metal, a plastic, a polymer, or any suitable material into which a light source 220 may be embedded. The light source 220 may be sufficiently embedded to define a light source surface flush with a top surface of the material of the illuminated hitch receiver 200 or of the second material 240, or may project slightly above the material of the illuminated hitch receiver 200/second material 240.

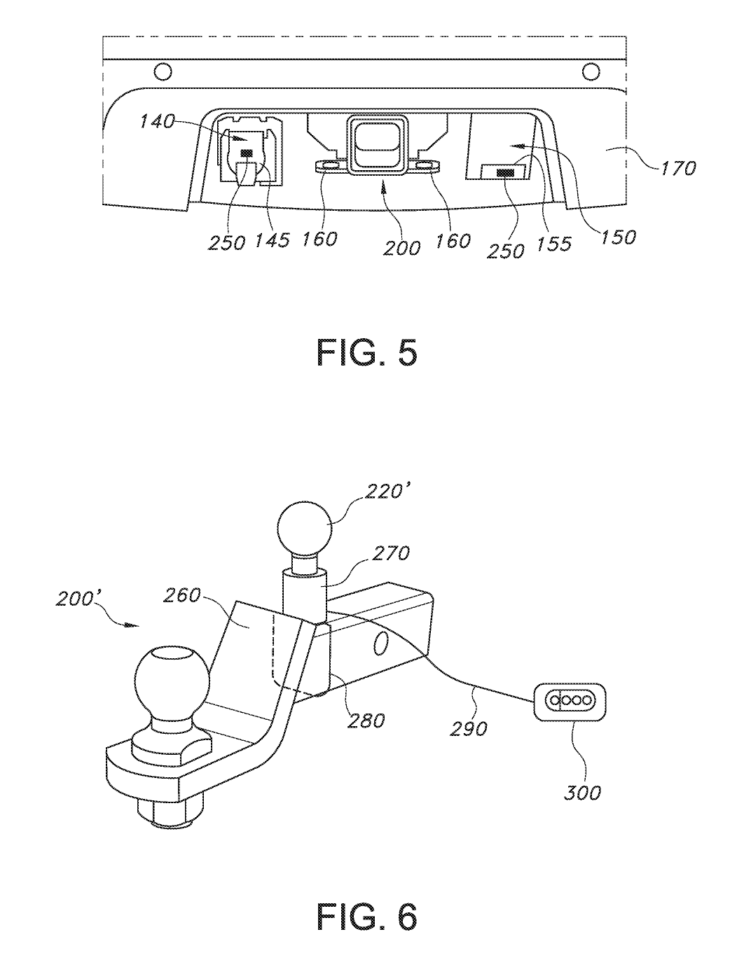

Light sources 220 fabricated of a continuously electroluminescent material could be provided. However, it is contemplated to provide a light source 220 in electrical communication with a power source (not shown), such as by suitable wiring (not shown). With reference to FIG. 5, there is shown an illuminated hitch receiver 200 substantially as described above and shown in FIG. 3. The depicted illuminated hitch receiver 200 further includes light source actuators 250 disposed on or adjacent to one or both of connectors 140, 150 and in electrical communication with light source 220, such as by suitable wiring (not shown).

Any suitable light source actuator 250 type could be implemented. However, for light source actuators 250 disposed on or adjacent to connectors 140, 150 as shown in the drawing figure, a more convenient arrangement is contemplated. As discussed above allow placing trailer wiring harness connectors of varying design and configuration (not shown) in electrical communication with a vehicle 100 power source such as a battery (not shown). To do so, a user simply accesses the appropriate connector 140, 150, lifts the respective cover 145, 155 according to the trailer wiring harness connector (not shown) configuration, and mates the two connectors.

For this arrangement, it is contemplated to provide a light source actuator 250 associated with, adjacent to, or disposed on one or both of connectors 140, 150 or one or both of covers 145, 155 whereby a user positioning her hand in proximity to a connector or a cover also causes actuation of the light source actuator and thereby causes the light source 220 to illuminate. To accomplish this, a variety of light source actuator 250 types are contemplated, including without intending any limitation a capacitive switch, a touch switch, a push switch, or other suitable types of actuator or activation devices/methods.

For example, where light source actuator 250 is a capacitive switch, as is known such switches are actuated by user body capacitance, i.e. an electrical charge causing the switch to detect a change in capacitance. In effect, such switches operate as short-range proximity sensors. For a touch switch (also called a resistance switch), as is known a user need only contact the switch to actuate a device in electrical communication therewith. Thus, for example, by associating a touch switch-type light source actuator 250 with one or both covers 145, 155, when the user lifts the appropriate cover she of necessity contacts the light source actuator and causes the light source 220 to illuminate. A similar function is achieved by associating a push switch-type light source actuator 250 with one or both covers 145, 155.

As will be appreciated, a user in performing the action of lifting a cover 145, 155 to connect a trailer wiring harness to one of connectors 140, 150, will of necessity actuate (or at least with limited additional hand motions required will very conveniently actuate) the light source 220 by way of the adjacent light source actuator 250. Thus, the area immediately adjacent to the illuminated hitch receiver assembly 200 will be illuminated, improving ease and convenience in the subsequent tasks attendant to attaching a trailer hitch to the hitch receiver.

An alternative embodiment of an illuminated hitch receiver assembly 200′ is depicted in FIG. 6, wherein is shown a light source 220′ configured for attaching to a drawbar 260. It will be appreciated that by use of the term “drawbar” herein, it is broadly intended to reference any particular hitch type attachable to a receiver-style hitch, including without intending any limitation a drawbar, a ball mount, a drawbar-mounted lunette eye for a pintle hitch, and others.

Any suitable light source as described above is contemplated for use. As shown in FIG. 6, the light source 220′ may be secured carried by a base 270. It is also contemplated to provide a protective housing (not shown) surrounding the light source 220′ and/or the base 270. A fastener 280 is provided to secure the light source 220′ to the drawbar 260. This may be any suitable fastener, including without intending any limitation one or more straps, one or more zip ties, one or more clamps, adhesive bonding, bolts or screws, studs, a clip-on feature, any other type of attachment method deemed appropriate in this application, or combinations.

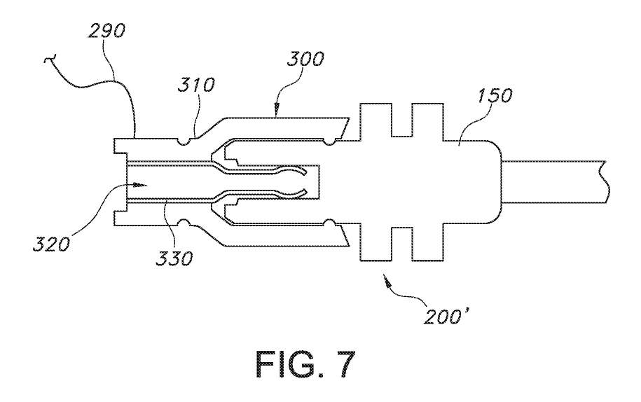

Light source wiring 290 and a light source connector 300 are provided to allow placing the light source 220′ in electrical communication with a power source (not shown). The light source connector 300 may be any suitable connector as is known in the art. In one embodiment (see FIG. 7), a pass-through-type connector 300 is provided, comprising a body 310 defining a central through-bore 320 including a metallic conductor 330. As is known, by use of the pass-through light source connector 300, the light source 220′ can be caused to illuminate by mating the light source connector to a vehicle-mounted connector in electrical communication with a power source (not shown), for example connector 150 as shown in FIG. 7. This illuminates the area adjacent to the hitch receiver assembly. A user can then proceed to attach a trailer hitch (not shown) to the drawbar 260, and can still place the trailer wiring harness connector (not shown) in electrical communication with a power source (not shown) by way of throughbore 320.

As will readily be appreciated, this latter embodiment provides a simple, effective aftermarket accessory. A user may, prior to a trailering operation, install a drawbar 260 and the described light source 220′, or alternatively install the light source 220′ on an already vehicle-mounted drawbar 260, and plug the light source connector 300 into a vehicle-mounted connector 140, 150 to cause the light source to illuminate, improving ease and convenience in the subsequent tasks attendant to attaching a trailer hitch to the hitch receiver.

Obvious modifications and variations are possible in light of the above teachings. All such modifications and variations are within the scope of the appended claims when interpreted in accordance with the breadth to which they are fairly, legally and equitably entitled.

What is claimed:

1. An illuminated hitch receiver assembly for a vehicle, comprising a light source associated with one of a hitch receiver or a drawbar and a light source actuator.

2. The assembly of claim 1, wherein the light source actuator is one of a capacitive switch, a touch switch, and a push switch.

3. The assembly of claim 1, wherein the light source is selected from the group consisting of one or more electroluminescent strips, one or more light-emitting diode (LED) strips, one or more LED bulbs, one or more luminescent optical fibers, one or more halogen bulbs, one or more fluorescent bulbs, or one or more incandescent bulbs, and combinations.

4. The assembly of claim 1, wherein the light source is integral to a portion of the hitch receiver.

5. The assembly of claim 4, wherein the hitch receiver comprises a light source-carrying flange.

6. The assembly of claim 4, wherein the light source actuator is carried by the vehicle-mounted wiring connector.

7. The assembly of claim 1, wherein the light source is connected to the drawbar by a fastener selected from the group consisting of one or more straps, one or more zip ties, one or more clamps, adhesive bonding, bolts or screws, studs, and a clip-on feature.

8. The assembly of claim 7, further including light source wiring and a light source connector adapted for placing the light source in electrical communication with a power source by way of the vehicle-mounted wiring connector.

9. The assembly of claim 8, wherein the light source connector is a pass-through connector.

10. A vehicle including the illuminated hitch receiver assembly of claim 1.

11. An illuminated hitch receiver comprising an integral light source.

12. The illuminated hitch receiver of claim 11, adapted for actuating the integral light source by a light source actuator associated with a vehicle-mounted wiring connector.

13. The illuminated hitch receiver of claim 12, wherein the light source actuator is one of a capacitive switch, a touch switch, and a push switch.

14. The illuminated hitch receiver of claim 11, wherein the light source is selected from the group consisting of one or more electroluminescent strips, one or more light-emitting diode (LED) strips, one or more LED bulbs, one or more luminescent optical fibers, one or more halogen bulbs, one or more fluorescent bulbs, or one or more incandescent bulbs, and combinations.

15. The illuminated hitch receiver of claim 11, comprising a light source-carrying flange.

16. A vehicle carrying the illuminated hitch receiver of claim 11.

17. A light source adapted for releasably connecting to a drawbar for a vehicle receiver hitch assembly.

18. The light source of claim 16, wherein the light source is connected to the drawbar by a fastener selected from the group consisting of one or more straps, one or more zip ties, one or more clamps, adhesive bonding, bolts or screws, studs, and a clip-on feature.

19. The light source of claim 16, further including wiring and a light source connector adapted for placing the light source in electrical communication with a power source by way of a vehicle-mounted wiring connector.

20. The light source of claim 19, wherein the light source connector is a pass-through connector.
